(19) United States
(12) Patent Application Publication
(10) Pub. No.: US 2023/0230099 A1
(43) Pub. Date: Jul. 20, 2023

(54) GOAL-BASED NEXT OPTIMAL ACTION RECOMMENDER

(71) Applicant: Zoho Corporation Private Limited, Kanchipuram District (IN)

(72) Inventors: Guruprasad Sundaresan, Trichy (IN); Cosmos Kerketta, Raipur (IN)

(73) Assignee: Zoho Corporation Private Limited, Kanchipuram District (IN)

(21) Appl. No.: 18/081,769

(22) Filed: Dec. 15, 2022

Related U.S. Application Data
(60) Provisional application No. 63/327,284, filed on Apr. 4, 2022.
(60) Provisional application No. 63/316,057, filed on Mar. 3, 2022.

(30) Foreign Application Priority Data
Jan. 14, 2022 (IN) 202241002224
Feb. 14, 2022 (IN) 202241007747

(51) Int. Cl. G06Q 30/01; G06Q 10/0637

(52) U.S. Cl. CPC G06Q 30/01; G06Q 10/0637

(57) ABSTRACT

The proposed G-NOA framework that is based on the goals set by the customer, accepts an input configuration with all necessary details from the customer. This framework supports multi-tenancy in a customer-centric fashion to facilitate modules of various businesses. The framework also has the capability of working according to a specific module of an organization and recommends the suitable NOA for that module. This is performed using the proposed Time-Effective Reinforcement Learning (TE-RL) model of the relevant module. The enhanced version of the TE-RL model namely Enhanced TE-RL helps in defining the state with multiple dimensions and in using ANN for predicting transition probabilities of states. The TE-RL model and the Enhanced TE-RL model are defined with time effective parameters like Time_Sliced_State (TSS), Enhanced-Time_Sliced_State (E-TSS) and Time_Sensitive_Action (TSA) for precise and accurate NOA recommendation. The model performs appropriate policy estimation and policy tuning using TSS, E-TSS and TSA parameters.

### TECHNICAL FIELD

Embodiments of the present disclosure are related generally to recommendation frameworks and, more particularly, to customer relationship management.

### BACKGROUND

Customer Relationship Management (CRM) is a set of practices, strategies, and technologies used by CRM users, hereafter “merchants,” to manage and analyze customer interactions and data throughout a customer-relationship cycle. The objective of CRM is to improve customer-service relationships in support of customer retention and sales growth. A typical customer-relationship cycle includes many individual processes and at least one well-defined goal. For example, the cycle for car sales may begin with lead management, move to sales, and then to post-sales support. These categories of customer interaction can be further divided into actions or sequences of actions that a merchant may take to meet customer expectations and advance merchant goals.

### SUMMARY

A Goal-based Next Optimal Action (G-NOA) recommender suggests NOAs to a merchant at various states of an ongoing customer-relationship cycle to progress toward a desired goal, such as the closing of a deal. This framework allows multi-tenancy in a customer-centric way to enable business modules for precise and accurate recommendations. A Time-Effective Reinforcement Learning (TE-RL) model and an enhanced TE-RL model are defined using time-effective parameters like time-sliced states (TSSs), Enhanced Time-Sliced States (E-TSSs), and Time-Sensitive Actions (TSAs).

A G-NOA recommender is implemented using a system of one or more computers configured to perform operations or actions by virtue of having software, firmware, hardware, or a combination of them installed on the system that in operation causes or cause the system to perform the actions. The system implements methods that include receiving a merchant goal relating a customer outcome, such as the sale of a product or service. The method also includes assigning the merchant goal to a merchant goal state corresponding to the customer outcome and producing one or more pre-goal states that represent stages in a progression of the merchant toward the merchant goal state. The G-NOA recommender automatically assigns merchant actions to each pre-goal state, and each action is calculated to transition the customer relationship from the pre-goal state toward the merchant goal state. Merchant actions can be suggested based on customer feedback. Some embodiments employ neural networks to estimate and update policies for suggesting next-optimal actions for different goal states.

### BRIEF DESCRIPTION OF THE DRAWINGS

The details of the present invention, both as to its structure and operation, can best be understood by referring to the accompanying drawings, in which like reference numbers and designations refer to the same or similar elements.

FIG. 1A depicts a networked communication system 100 that allows merchants 101 and 102 with access to a server or servers 103 to manage offers goods and services (e.g. cars, boats, and software support) via a network of wired and wireless communication devices.

FIG. 1B depicts merchant-centric G-NOA recommender 110 of FIG. 1A in accordance with one embodiment. G-NOA recommender 110 is a distributed computer system, a networked collection of computational resources (e.g. processors and memory).

FIG. 2 is a flowchart 200 illustrating the operation of G-NOA framework 135i of FIG. 1B in accordance with one embodiment.

FIG. 3 is a flowchart 300 detailing an example of step 205 of FIG. 2 to invoke module Time_Sliced_State, TSS for a merchant dataset.

FIG. 4 is a flowchart 400 detailing an example of step 210 of FIG. 2 to invoke module Time_Sensitive_Action, TSA for a merchant dataset.

FIG. 5 is a flowchart 500 detailing an embodiment of step 215 of FIG. 2, a method for generating and updating a Probability Transition Matrix (PTM).

FIG. 6 is a flowchart 600 detailing an embodiment of policy-estimation step 250 FIG. 2, a process by which each pre-goal TSS is assigned a value proportional to the rewards available to the pre goal state on transitioning to its neighboring states (TSS’).

FIG. 7 is a flowchart 700 depicting an embodiment of policy tuning process 265 of FIG. 2, a process that computes the optimal TSA for each TSS.

FIG. 8 is a table 800 listing examples of Time sliced states (TSSs) for several records.

FIG. 9 is a table 900 listing examples of Time Sensitive Actions (TSAs) for the records of FIG. 8.

FIG. 10 depicts a Transition Counter Matrix (TCM) 1000, table in which the rows denote a current state and the columns denote the next state.

FIG. 11 depicts a Probability Transition Matrix (PTM) 1100 for a particular action, “CALL_0”.

FIG. 12 depicts a Final Policy table 1200 illustrating a policy data structure derived using the policy estimation and tuning processes in accordance with one embodiment.

FIG. 13 is a flowchart 1300 depicting an illustrative use-case for an embodiment of G-NOA framework 135i.

FIG. 14 is a flowchart 1400 detailing an embodiment of step 215 of FIG. 2 in which a Probability Transition Matrix (PTM) is generated and updated using an artificial neural network.

FIG. 15 depicts a general-purpose computing system 1500 that can serve as a client or a server depending on the program modules and components included.

### DETAILED DESCRIPTION

A Goal-based Next Optimal Action (G-NOA) recommender suggests Next Optimal Actions (NOAs) to a merchant at various states of ongoing customer-relationship cycles. Merchant NOA suggestions are based on goals set by the merchant and obtained as part of an input configuration. The input configuration so received can include an organization_id, module name, states, actions, Desired Goal (DG), and Undesired Goal (UG). The journey through a customer-relationship cycle involves state transitions that progress toward a DG or UG, with each state transition caused by an action (A) and producing an indication to the merchant of the customer having transitioned to the next state. Rewards given for each state transition urge the customer-relationship cycle toward an end state relating a desired customer outcome. In some embodiments, the rewards for transitioning to the DG, the UG, and any intermediate state are set to 100, -100, and 0, respectively. One of these rewards is applied to each instance of historical state-transition data that progressed toward the merchant goal state corresponding to the DG and the UG. The G-NOA recommender uses these rewards to adjust a model of the customer-relationship cycle to suggest more productive NOAs at each state of the cycle. The resultant goal-oriented NOAs improve the likelihood and pace of reaching the DG of obtaining a positive customer outcome. In some embodiments the G-NOA recommender employs an artificial neural network to adjust the model or models to suggest more productive NOAs.

One embodiment of an input configuration obtained from a merchant is modeled as: Input_Configuration = {O, M, A, {S, DG, UG}}, where:
Organization_ID (O): A unique identifier for the merchant using the CRM application. Systems detailed herein can support multiple merchants with optimized G-NOA recommendations. In this context, a merchant is a company or individual who engages with the customer with a particular goal in mind. Merchants can sell wholesale or retail, and these categories can be further segregated into so-called “brick-and-mortar” and ecommerce, the latter referring to sales predominantly or exclusively over the Internet.
Module (M): A set of modules M={Mi} where 1<=i<=m, m is an integer, each module being a process for manipulating data in the CRM application. Examples of CRM modules include processes for Lead management, Marketing, Sales, Human resource management, analytics, and project management. An instance of a module is termed a “Record,” and each record includes a sequence of states and supports state transitions.
Actions (A): Actions are available operations that influence a change in the state of a record, and thus initiate transitions between the states. Actions include reaching out to a customer via text, call, or ad placement; making or accepting an offer for a good or service; running a credit check; making a sale; receiving payment; accepting a return; or the passage of a designated time. Actions can associate rewards with state transitions. Rewards can be positive or negative depending upon whether a state transition advances toward a DG. A set of actions can be specified as Action={Aₖ} where 1<=k<=p, p is an integer.
States (S): A module has an exhaustive set of states, each state representing the current state of a record. For example, in a Deal management record, states might include goal states Deal_won and Deal_lost, and pre-goal states Qualification, Negotiation, Engaged, and Prospecting. Let S represent a set of states such that, State={Sⱼ} where 1<=j<=n, n is an integer.
Desired Goal (DG): DG represents a goal state that the merchant is intending to reach (e.g. Deal_won). DGs can be specified by a merchant relating a positive customer outcome, such as to close a sale of a good or service.
Undesired Goal (UG): UG represents a goal state that the merchant hopes to avoid (e.g. Deal_lost). UGs can be specified by a merchant relating a negative customer outcome, such as to lose a sale.

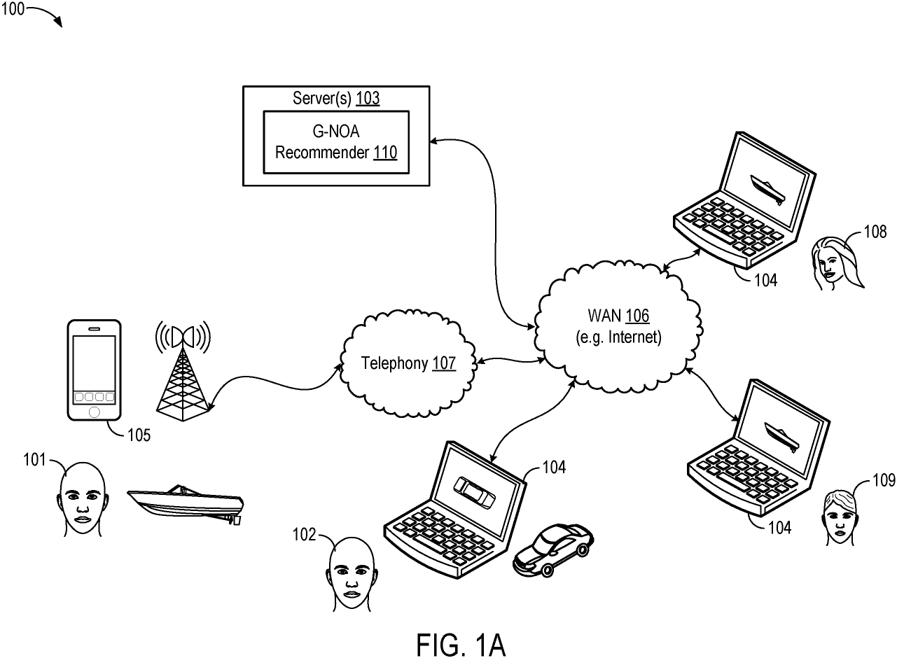

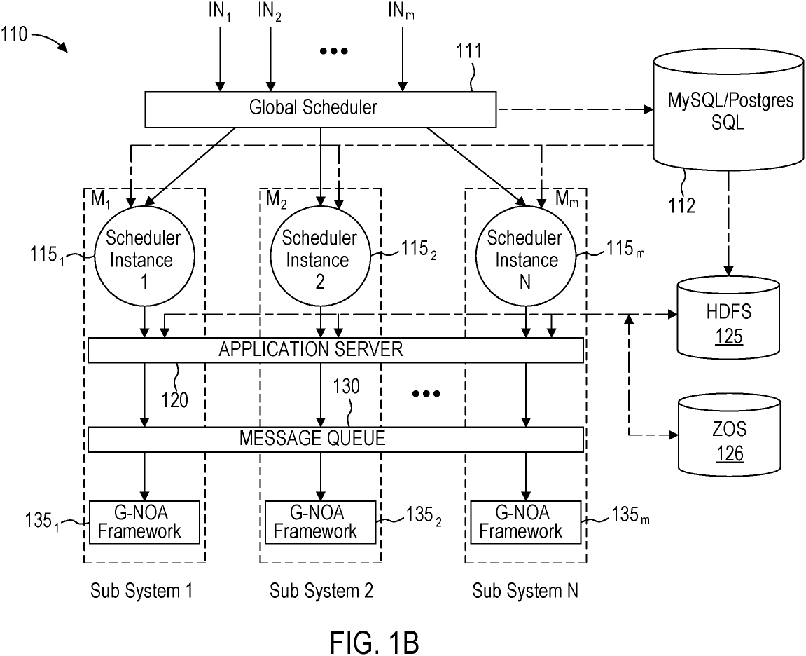

FIG. 1A depicts a networked communication system 100 that allows merchants 101 and 102 with access to a server or servers 103 to manage offers goods and services (e.g. cars, boats, and software support) via a network of wired and wireless communication devices—e.g. a laptop computer 104 and a mobile device 105—via a wide-area network 106 (e.g., the Internet) and available wireless telecommunication infrastructure 107 (e.g. one or more cellular networks). Potential customers 108 and 109 can interact with merchants 101 and 102 via the same network infrastructure using similar client devices. A merchant-centric G-NOA recommender 110 supports merchants 101 and 102 in their efforts to close sales with potential customers 108 and 109 by suggesting merchant actions. NOA recommender 110 need not be a single machine or a set of machines administered by a single entity. In some embodiments, for example, recommender 110 represents a cloud-based environment that supports NOA recommendation services made available to users and institutions via the Internet.

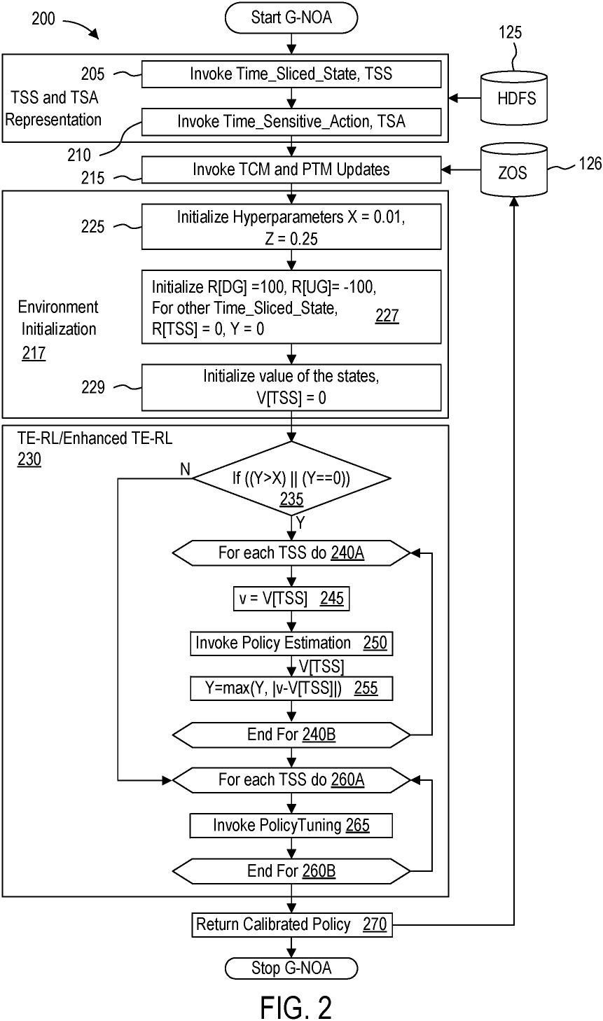

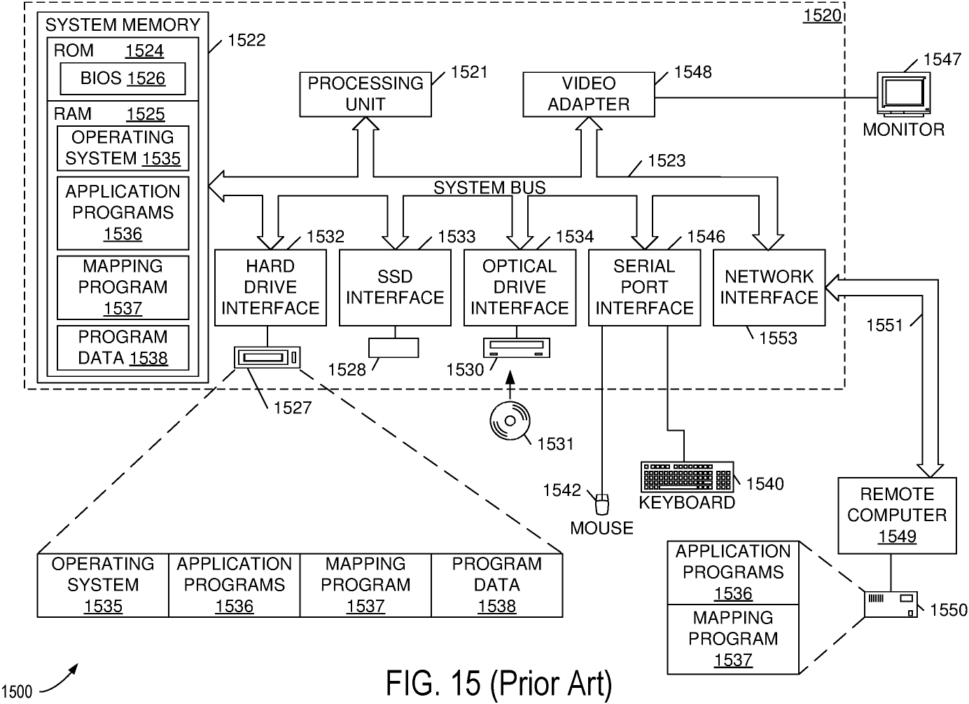

FIG. 1B depicts merchant-centric G-NOA recommender 110 of FIG. 1A in accordance with one embodiment. G-NOA recommender 110 is a distributed computer system, a networked collection of computational resources (e.g. processors and memory). Recommender 110 supports one or more merchants, each of which can be siloed to protect their proprietary data. G-NOA recommender 110 includes one or more modules M₁...Mₘ for each tenant merchant, each module recommending NOAs for achieving a merchant’s DG or DGs. Merchant NOA recommendations are improved by training a TE-RL/Enhanced TE-RL model (as shown e.g. in 230 of FIG. 2) with the historical data of the relevant module. Recommender 110 is implemented on hardware with system memory and processing units that communicate with merchants and their customers via network interfaces. Suitable hardware is detailed below in connection with FIG. 15.

A global scheduler 111 receives input-configuration data IN₁...INₘ to configure the activity of respective modules M₁...Mₘ. The configuration data can be obtained from several departments of the same or different merchant organizations and stored in a MySQL/Postgres SQL database 112 that collects and maintains historical data of customer records and other logs from a CRM system. Scheduler 111 distributes the configuration data from MySQL/Postgres SQL database 112 to different subsystems. Scheduler 111 also initiates, for each module Mi, a scheduler instance 115ᵢ that runs e.g. every 15 days. Each scheduler instance 115ᵢ fetches appropriate input configuration details from the MySQL/Postgres SQL database 112 and passes those details to an application (app) server 120, a combination of computer hardware and software that provides functionality and storage for customer and merchant client devices.

App server 120 queries a file system, e.g. a Hadoop Distributed File System (HDFS) 125, based on the configuration details given by each of scheduler instances 115ᵢ and writes the resultant dataset back to the file system. HDFS 125 can be thought of as a database where data relevant to modules is copied from database 112 e.g. at regular time intervals. Queries to HDFS 125 can be used in a Time-Effective Reinforcement Learning (TE-RL) model as detailed below. An object Zoho Object Storage (ZOS) 126 stores a Transition Counter Matrix (TCM), a Probability Transition Matrix (PTM), and updated policies. Application server 120 can pass this information to a Message Queue 130, which pushes the path of the necessary data and instructions to a corresponding G-NOA framework 135ᵢ where those data and instructions will be used to train the associated module. In this context, a “framework” is a software environment that provides the functionality detailed herein as part of a larger computational system. A software framework can include e.g. support programs, compilers, code libraries, toolsets, and application programming interfaces (APIs) that bring together all the different components to enable development of a project or system.

FIG. 2 is a flowchart 200 illustrating the operation of G-NOA framework 135ᵢ of FIG. 1B in accordance with one embodiment. Flowchart 200 details how framework 135ᵢ estimates and tunes a policy for recommending merchant at different times in a customer-relationship cycle. The framework refers to an abstraction for a set of underlying processes such that a merchant can accomplish the intended work in a seamless fashion. Accessing HDFS 125, G-NOA framework 135ᵢ represents each stage in a merchant’s customer-relationship cycle as a Time_Sliced_State (TSS) (step 205) and each action that can be taken or recommended from a TSS as a Time_Sensitive_Action (TSA) (step 210). TSSs are timed, or “sliced,” based on the time since the active state or record was created. Slicing makes states time conscious, say, to differentiate between a customer staying in a particular state for a long time and a customer newly entering the same state. TSAs are actions sensitized based on a time factor to optimally suggest an NOA for a given TSS. A TSA gives the due time for the optimal action, thereby suggesting the urgency of the action to be taken by the merchant, the CRM user.

Next, G-NOA framework 135ᵢ invokes Transition Counter Matrix (TCM) and Probability Transition Matrix (PTM) updates (step 215). Each TSA has a TCM that maintains counts for the number of times the action TSA induced a transition from a current TSS to a next state. The transition counter matrix TCM for each time-sensitive action TSA is used to create a corresponding probability transition matrix PTM that relates states TSSs with the probabilities that the action TSA will induce a transition to a next TSS. The PTM probabilities associated with a TSS will later guide the selection of an NOA for that TSS. Upon the receipt of an indication that a customer has transitioned to a new pre-goal state, Framework 135ᵢ sends a message (e.g. email or text) to the merchant recommending an NOA.

The next sequence 217 initializes variables used to calibrate an NOA policy Pol for framework 135ᵢ. Framework 135ᵢ initializes hyperparameters X and Z (step 225), where X represents the threshold for a change in a value V to stop a subsequent policy-estimation process and Z represents a Discount Factor that governs the impact of future states/next time-sliced states TSS’ that can be achieved from a current state TSS on taking a time-sensitive action TSA. Next, in step 227, reward values for transitioning to a desired goal (R[DG]), an undesired goal (R[UG]), and various other pre-goal states or Time_Sliced_States (R[TSS]) are respectively initialized to 100, -100, and 0. A variable Y is set to 0, Y representing the change in a value V[TSS] that in turn represents the desirability of a customer-relationship cycle being in a given state TSS, the higher the value V[TSS] the better. The value V[TSS] for each TSS is initialized to zero in this example (229).

After initialization, the process of FIG. 2 enters a TE-RL/Enhanced TE-RL sequence 230 that estimates and tunes policy prescriptions for each time-sliced state TSS. Per decision 235, G-NOA framework 135ᵢ checks for the condition (Y>X) or (Y==0). If the condition is satisfied, then, for each TSS (for loop 240A/B), a temporary variable v is assigned initial value V[TSS] (step 245). The policy estimation process 250 is invoked for the TSS to return an updated value V[TSS] representing the desirability of being in the state from a perspective of achieving the desired goal DG. The difference between the value of V[TSS] before and after invoking policy estimation and updated V[TSS] is also determined. The value Y is updated to the larger of variable Y and the absolute value of the difference between variable v and V[TSS] (step 255). Each TSS is thus assigned value Y based on the rewards available to move to its neighboring state or states TSS’. The higher the Y value, the more likely a state transition will move towards the desired goal.

Per for-loop 260A/B, a policy-tuning process 265 is invoked for each time-sliced state TSS to compute the best time-sensitive action TSA, which is to say the action most likely to lead towards the desired merchant goal state. Policy-tuning process 265 suggests a time-effective NOA as a consequence of time-precise calculations made in policy-estimation process 250. Each NOA thus computed includes an action due time as a severity measure to suggest the timeframe within which the suggested action should be taken. The calibrated policy is then returned to ZOS 126 (step 270). G-NOA framework 135i thus updates a TE-RL environment 230, which can be expressed as TE-RL= {M, {TSS, DG, UG}, TSA, R, Pol}, where M, TSS, DG, UG, TSA and R represent Module, Time_Sliced_State, Desired Goal, Undesired Goal, Time_Sensitive_Action, and Reward as noted previously. Pol, for “Policy,” is a state-to-action mapping in TE-RL environment 230. That is, from any TSS the policy Pol selects the G-NOA to move toward the desired goal.

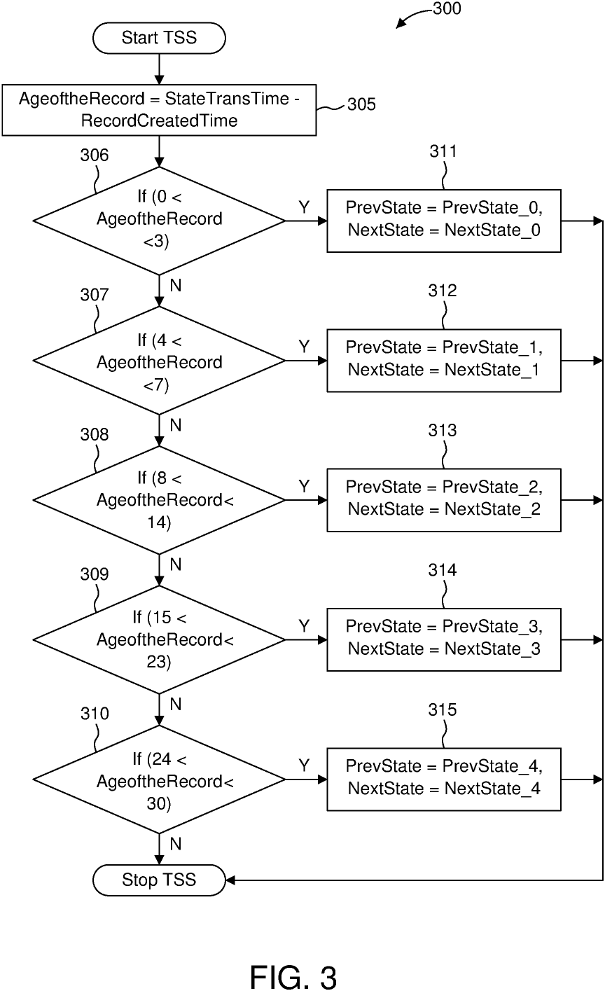

FIG. 3 is a flowchart 300 detailing an example of step 205 of FIG. 2 to invoke module Time_Sliced_State for a merchant dataset. G-NOA framework 135i calculates, in step 305, the age of the record (AgeoftheRecord) as the difference between a time of state transition (StateTransTime) and a time of record creation (RecordCreatedTime). Decisions 306-310 then select one of a pair of previous and next states 311-315 based on the computed AgeoftheRecord. Each pair of states 311-315 specifies a previous state (PrevState) and a next state (NextState) from five previous states PrevState_[4:0] and next states NextState_[4:0], each a time-sliced state TSS based on the age of the record.

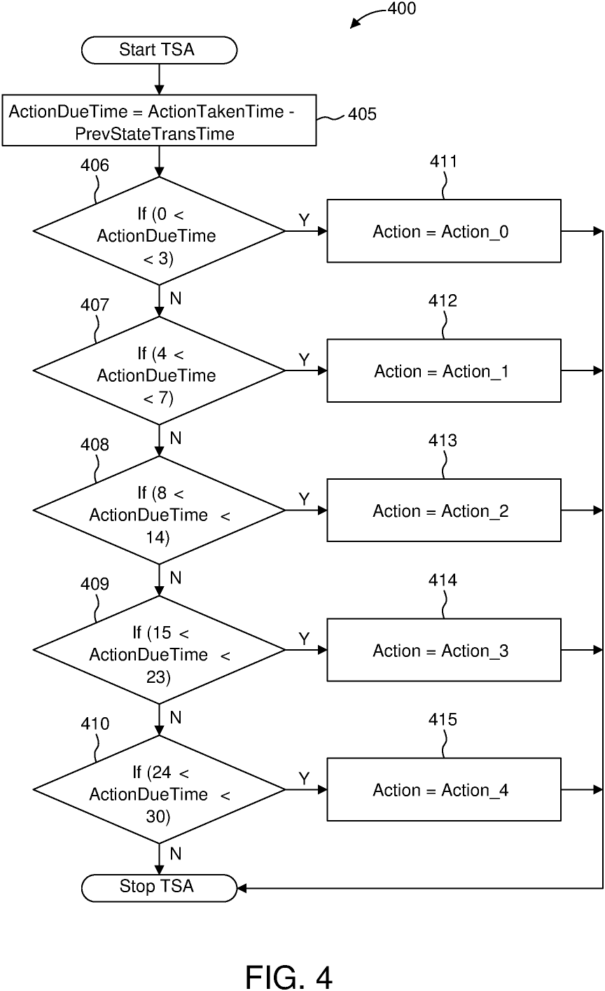

FIG. 4 is a flowchart 400 detailing an example of step 210 of FIG. 2 to invoke module Time_Sensitive_Action for a merchant dataset. G-NOA framework 135ᵢ calculates, in step 405, an action-due time (ActionDueTime) as the difference between an action-taken time (ActionTakenTime) and a previous state-transition time (PrevStateTransTime). Decisions 406-410 then select a corresponding one of actions 411-415 (Action_[4:0]) based on action-due time ActionDueTime.

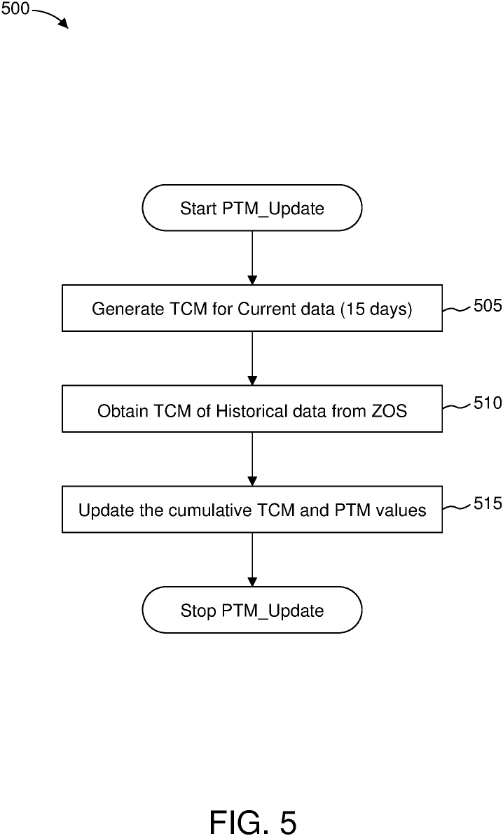

FIG. 5 is a flowchart 500 detailing an embodiment of step 215 of FIG. 2, a method for generating and updating a Probability Transition Matrix (PTM). G-NOA framework 135ᵢ generates a transition-counter matrix (TCM) using data from scheduler 115ᵢ covering the most-recent 15-day period (step 505) and obtains older TCM data from ZOS 126 (step 510). G-NOA framework 135ᵢ then uses the recent and historical data to update the cumulative TCM and PTM values (step 515). Cumulative TCM values are created for every state TSS by storing the number of transitions from a given state TSS to each of its neighboring states (TSS’) that result from a specific action TSA, while each PTM value is updated by normalizing the values of the corresponding updated TCM.

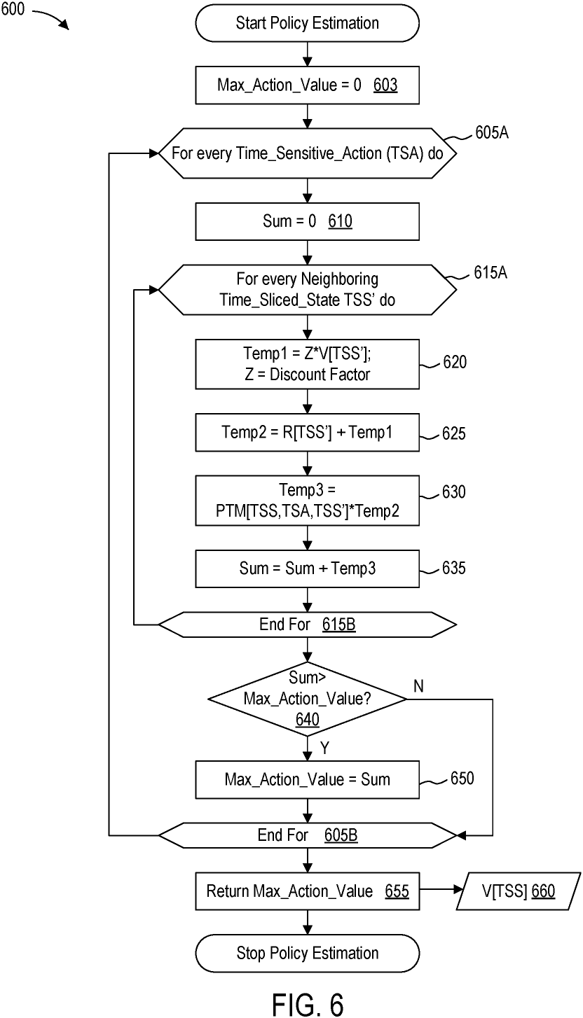

FIG. 6 is a flowchart 600 detailing an embodiment of policy-estimation step 250 FIG. 2, a process by which each pre-goal TSS is assigned a value proportional to the rewards available to the pre-goal state on transitioning to its neighboring states (TSS’). Each TSS has one or more TSAs that can produce a transition to a neighboring state (TSS’). G-NOA framework 135ᵢ begins by setting a variable Max_Action_Value to zero (step 603) before considering each TSA available to a TSS in using a sequence of steps captured within a for-loop 605A/B that finds the action TSA corresponding to the greatest Max_Action_Value. Each TSA is responsible for a customer transitioning from one time-sensitive state TSS to another state TSS’. For each of these state transitions, different time-sensitive actions TSAs return different values and the maximum of all these is assigned to the Max_Action_Value.

A ‘Sum’ variable is initialized to zero (step 610). Then, per a second for-loop 615A/B, for every neighboring state TSS’ a variable Temp1 is found by multiplying a discount factor Z with V[TSS’] (step 620). Value V[TSS’] was initially set to zero in FIG. 2. In step 625, a second variable Temp2 is calculated as the sum of a reward on reaching the neighboring state TSS’ (R[TSS’]) and Temp1. Variable Temp2 is then used in step 630 to calculate a third variable Temp3, the product of a variable Temp2 and a probability of transition from current state TSS to neighboring state TSS’ for a given TSA. The variable Sum is then increased by the value of variable Temp3 (step 635). For loop 615A/B repeats until every neighboring state TSS’ is considered for a given time-sensitive action TSA. The Sum variable then holds the cumulative sum of values received on moving from the current time-sensitive state TSS to the neighboring time-sensitive states TSS’ that can be arrived at for a given time-sensitive action TSA.

Per decision 640, sum variable Sum is compared to Max_Action_Value when for loop 615A/B completes. If Sum is greater than Max_Action_Value, then the current value of Sum is assigned to Max_Action_Value (step 650); otherwise, Max_Action_Value remains unchanged. Per for loop 605A/B, the process repeats from step 610 for each additional time-sensitive action TSA. In this way the value for Max_Action_Value is updated with the maximum value and returned (step 655) as an updated value for V[TSS] 660, a measure of the desirability of being in the state TSS under consideration in moving towards the desired goal DG.

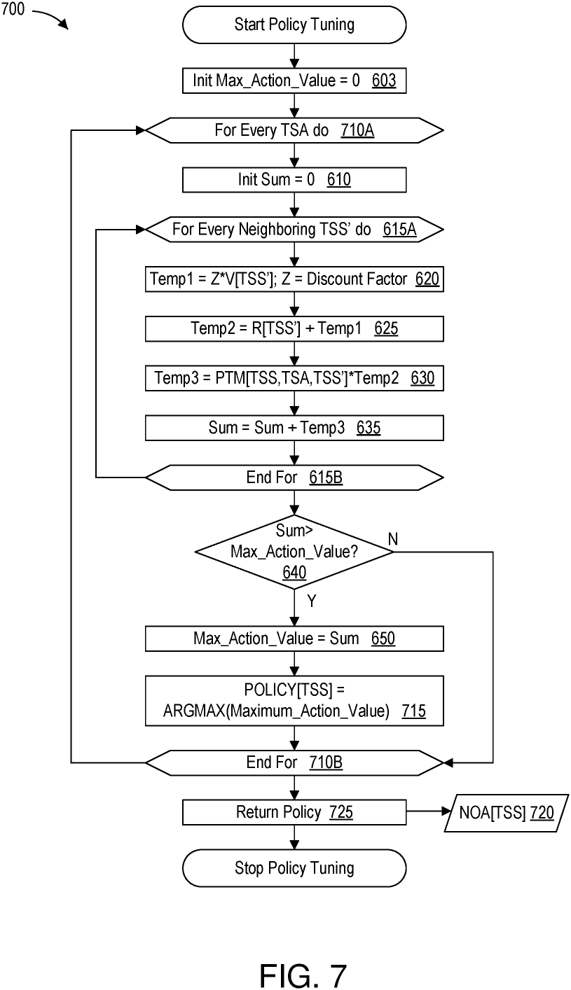

FIG. 7 is a flowchart 700 depicting an embodiment of policy tuning process 265 of FIG. 2, a process that computes the optimal time-sensitive action TSA for each tine-sliced state TSS. The optimal action TSA is, in this example, the one that leads to the neighboring states TSS’ with the highest value Max_Action_Value as reflected in the value for V[TSS] 660. The policy-tuning process of flowchart 700 is like the policy-estimation process of flowchart 600 in FIG. 6, like-numbered elements being the same. The differences are that the for-loop 610A/B used in flowchart 600 to consider every time-sensitive action TSA is modified to a for-loop 710A/B that includes a step 715 for loading a policy variable POLICY[TSS] to the maximum action value and the process returns a Policy (step 720). Upon completion of for-loop 615A/B, and per decision 640, if the value Sum exceeds the Max_Action_Value, ARGMAX of Max_Action_Value is determined and assigned to POLICY[TSS]. ARGMAX represents the action TSA for which the Max_Action_Value has been obtained. Variable ARGMAX thus ultimately reaches a value proportional to the action most likely to move the process toward the desired goal DG from a given state TSS. This action, the next-optimal action NOA[TSS] 720 for the state under consideration, is returned as Policy in step 725.

The following discussion illustrates aspects of a G-NOA framework in accordance with one embodiment using the example of a retail boat dealer, a merchant who maintains a list of prospective customers. Some prospective customers have enquired about the latest boat on offer. Sales representatives for the merchant perform customer-support actions to interact with these individuals with the desired goal (DG) of selling a boat, or “winning a deal,” and the undesired goal (UG) of losing the sale (DG=Deal won, UG=Not interested).

Deal progression, from enquiry to Deal won, moves between deal-progression states responsive to the customer-support actions. These actions might include phone calls, emails, remote and in-person meetings, and directed advertisements. G-NOA recommender framework 135ᵢ in this example traverses the following deal-progression states (Deal_Progression_States) and customer-support actions (Customer_Support_Actions) in support of boat sales. Deal progression begins when a merchant designates a “Qualified Lead,” a commercial transaction to be pursued by the merchant’s sales force.

TABLE 1

| | |
|---|---|
| Deal_Progression_States | Customer_Support_Actions |
| Qualified Lead | Call |
| Prospecting | Mail |
| No response | Meet_In_Person |
| Quotation sent | |
| Negotiation | |
| Deal won | |
| Not interested | |

The below shows some examples of state transitions based on certain actions,
Qualified Lead -> call -> No response -> call -> No response -> mail -> No response -> mail -> Not interested
Qualified Lead-> call -> Prospecting -> call -> No response -> mail -> Prospecting -> call -> Quotation sent -> Meet in Person-> Quotation Sent -> mail -> Negotiation -> call -> Deal won
Qualified Lead -> call -> No response -> call -> No response -> mail -> No response -> mail -> Not interested

The following sections details that make up G-NOA recommender framework 135ᵢ in some embodiments. The data structures include Time_Sliced_States TSSs, Time_Sensitive_Actions TSAs, a Transition Counter Matrix TCM, a Probability Transition Matrix PTM, and a Policy.

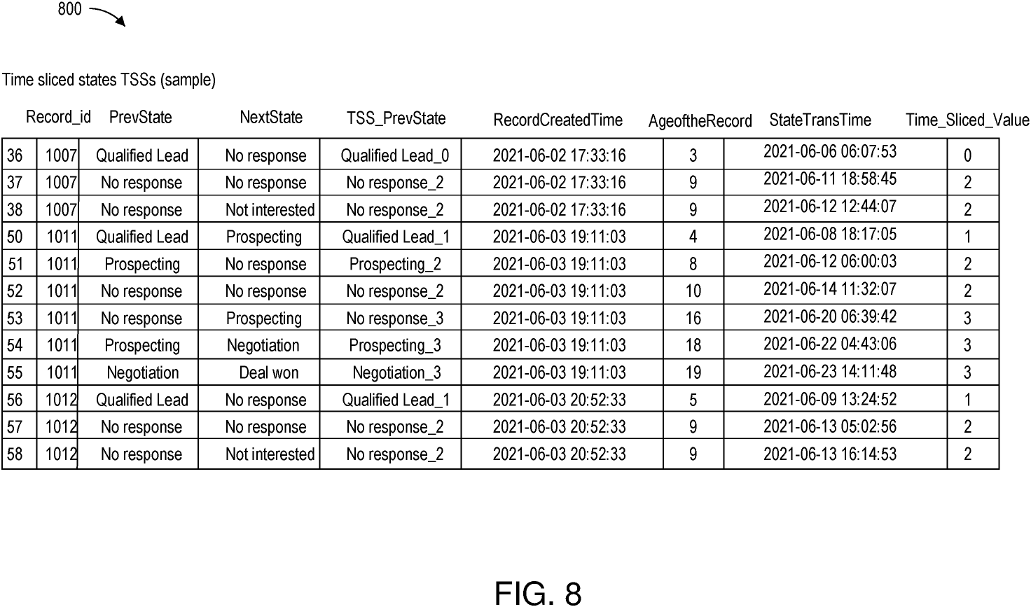

FIG. 8 is a table 800 listing examples of time-sliced states TSSs for several records. Each state has an AgeoftheRecord time noting the time since the entry of the customer record into the sales process until the point the next state transition takes place. In the uppermost row of table 800, for example, where the record identifier Record_id is 1007, the time factor AgeoftheRecord is 3 days. Other entries in the uppermost row are the previous state PrevState “Qualified Lead,” the next state NextState is “No response,” the TSS_PrevState “Qualified Lead_0,” and TSS_NextState “No response_0,” the time record 1007 was created “RecordCreatedTime,” the state-transition time “StateTransTime,” and the time-sliced value “Time_Sliced_Value.” The Time_Sliced_Value is the binned/sliced value that represents the interval the AgeoftheRecord falls in.

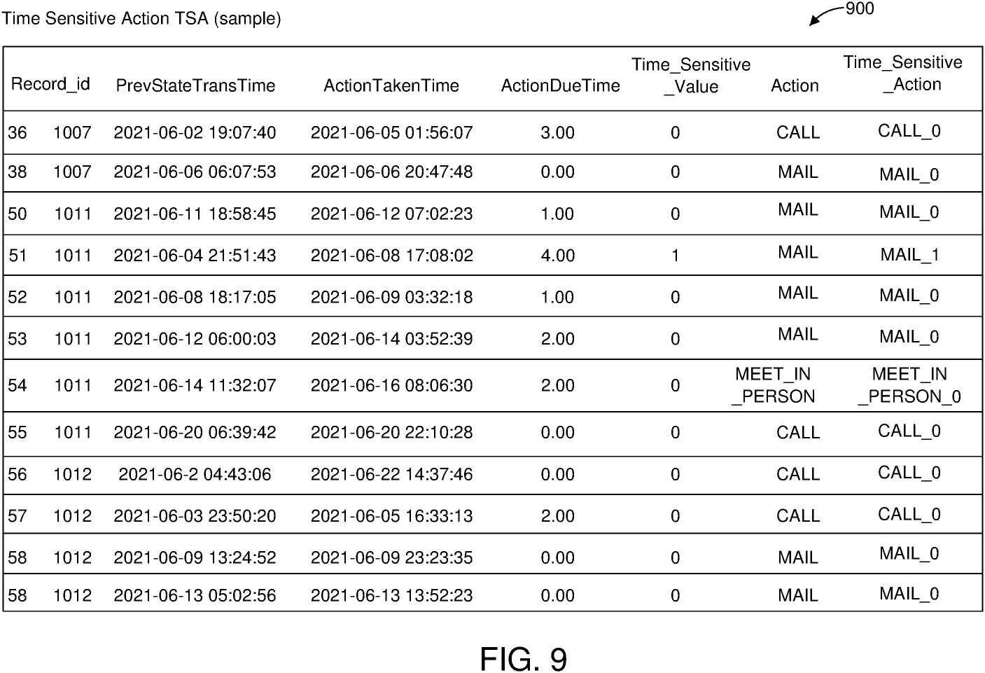

FIG. 9 is a table 900 listing examples of time-sensitive actions TSAs for the records of FIG. 8. TSAs are actions with an associated time factor (ActionDueTime), the time interval within which the action should be executed. In the uppermost row of table 900, where the record identifier Record_id is 1007, time factor ActionDueTime is 3 days and the associated time-sensitive action Time_Sensitive_Action is CALL_0. The “0” in CALL_0 corresponds to the binned/sliced value of 3, the difference between the PrevStateTransTime and the ActionTakenTime.

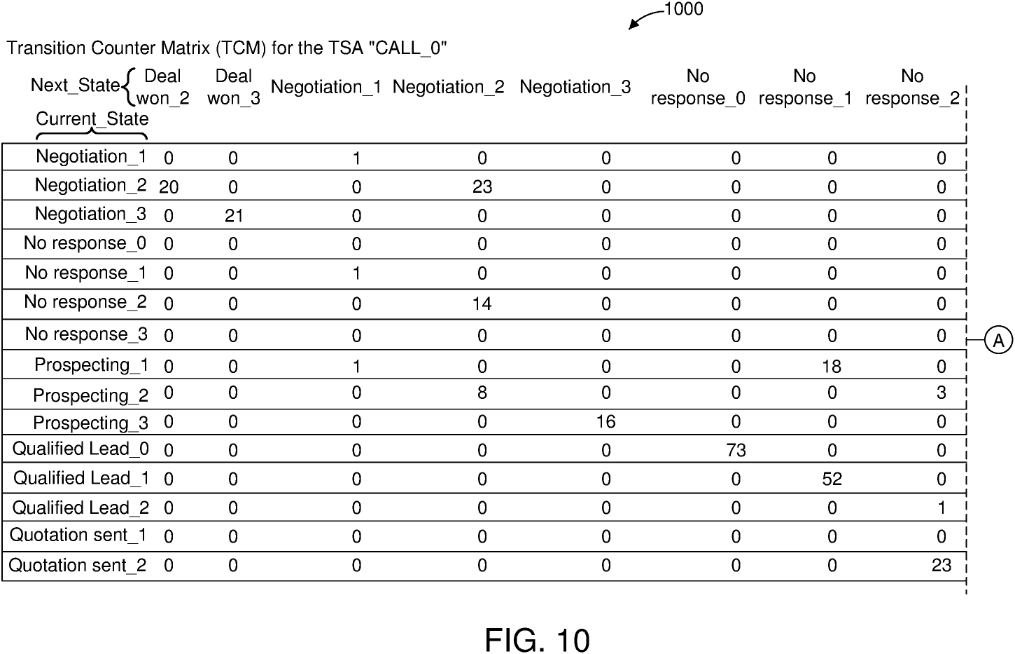

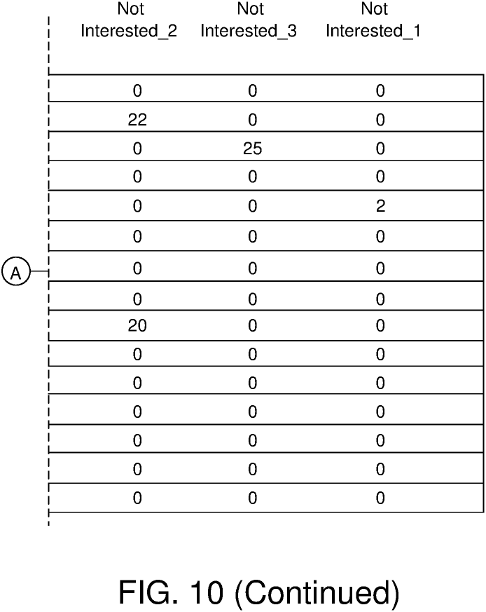

FIG. 10 depicts a Transition Counter Matrix (TCM) 1000, a table in which the rows denote current states and the columns denote next states. Each cell in TCM 1000 denotes the number of historical transitions from the current state to the next state for an action. For example, when the Current_State is “No response_2” and the Next_State is “Negotiation_2”, the cell value is 14, denoting the count of the transitions that took place for “CALL_0” action. G-NOA framework 135ᵢ generates a TCM for all the available TSAs.

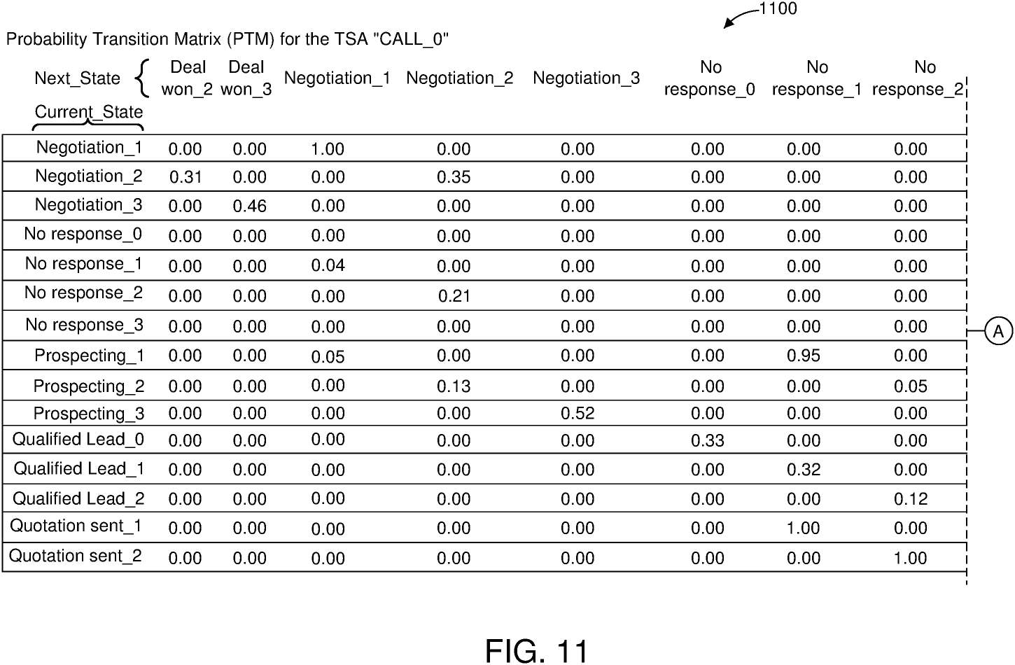

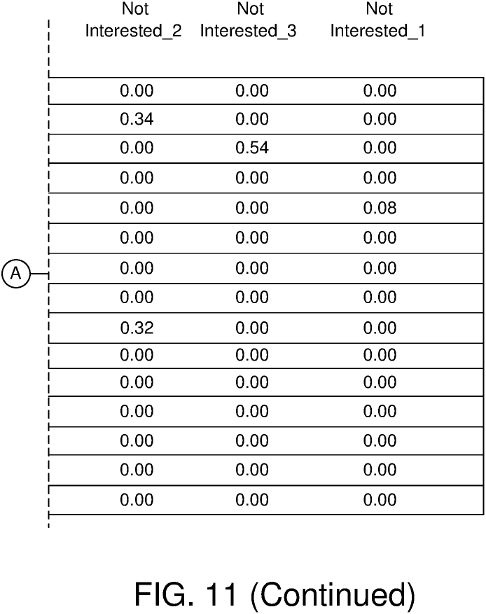

FIG. 11 depicts a Probability Transition Matrix (PTM) 1100 for a particular action, “CALL_0”. The rows denote current states and the columns the next states. Each cell in the table denotes the probability of transitioning from the current state to the next state for the TSA “CALL_0”. A PTM is generated for all TSAs. For example, when the Current_State is “No response_2” and the Next_State is “Negotiation_2”, the cell value is 0.21, denoting a 21% probability of transition between the states.

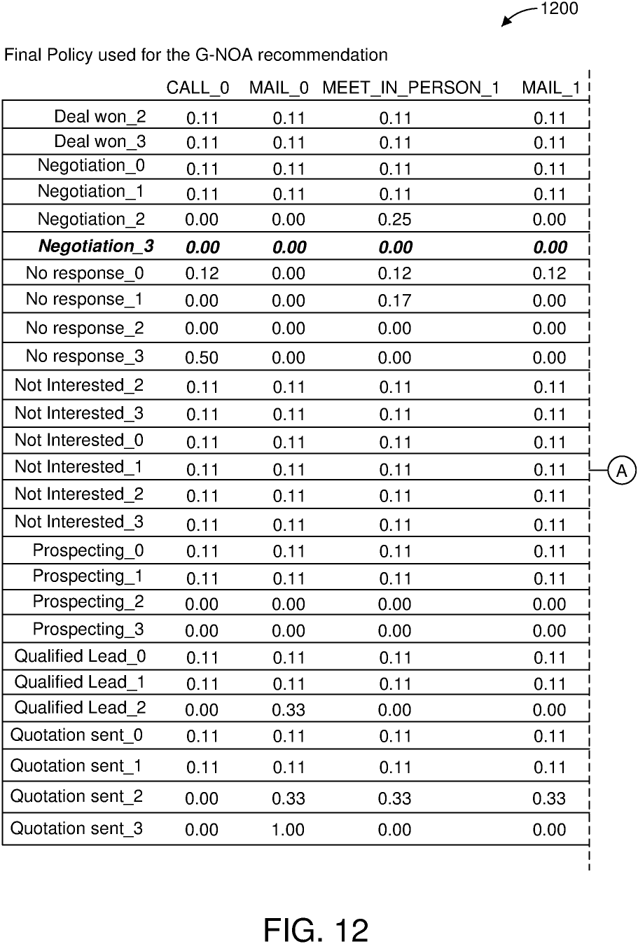

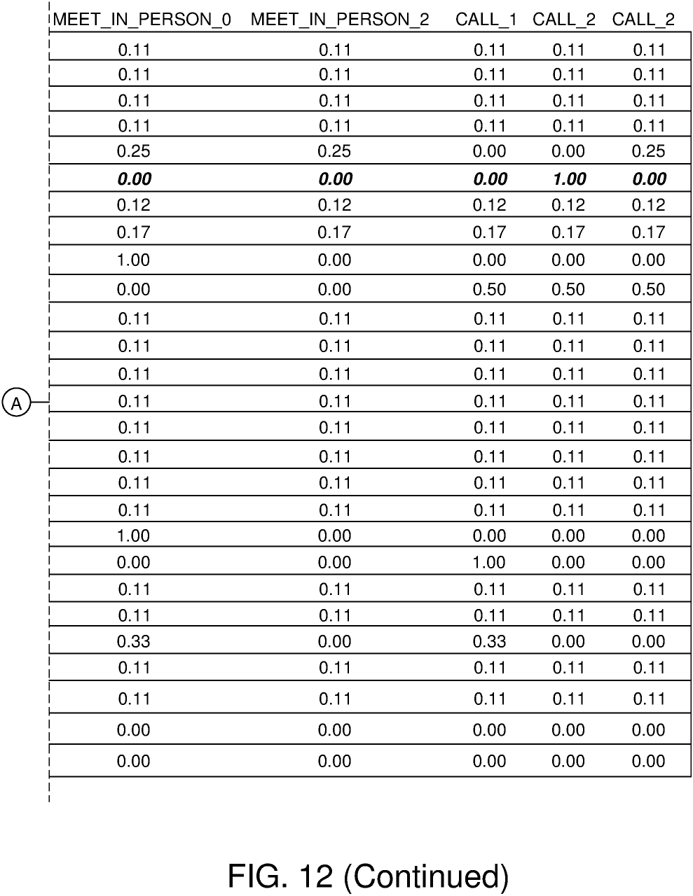

FIG. 12 depicts a Final Policy table 1200 illustrating a policy data structure derived using the policy estimation and tuning processes in accordance with one embodiment. The policy estimation process results in a mapping between TSSs and corresponding TSAs. The policy tuning uses the results of policy estimation to suggest the NOA for any TSS. As shown in FIG. 12, rows denote the TSSs and the column denote the available TSAs. Each cell denotes the probability of a TSA being the optimal action for the corresponding TSS. For example, when the TSS is “Negotiation_3”, the row highlighted in bold, italic text, the next optimal action (NOA) is “CALL_2”. This NOA is arrived at by checking the TSA with the highest probability for “Negotiation_3”, which is 1.00 for “CALL_2” in this example.

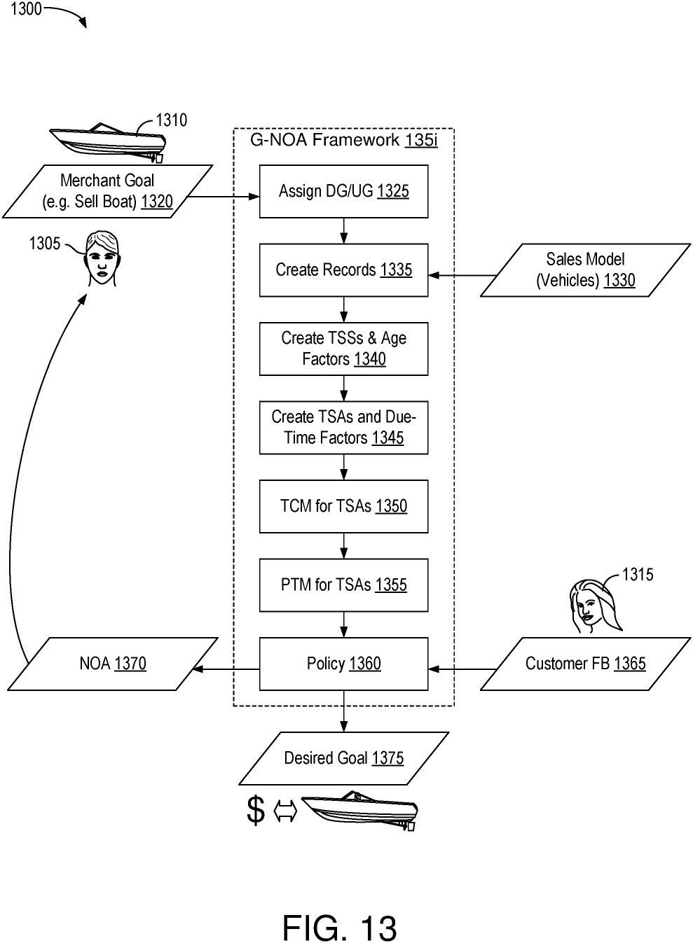

FIG. 13 is a flowchart 1300 depicting an illustrative use-case for an embodiment of G-NOA framework 135ᵢ. A merchant 1305 is selling a boat 1310 using a CRM empowered by framework 135ᵢ to recommend NOAs optimized toward selling boat 1310 to a prospective customer 1315. To start, framework 135ᵢ receives preliminary information 1320 from merchant 1305, this information including a desired goal (e.g., to sell boat 1310). In step 1325, framework 135ᵢ assigns the desired goal to merchant 1305. Desired Goals, such as selling the boat to the customer and Undesirable goals, such as a customer request to desist, can also be defined in this step. Information 1320 can also include an organization id unique to merchant 1305, a module name, merchant-specific or more general deal-progression states (Deal_Progression_States), and merchant-specified or more general customer-support actions (Customer_Support_Actions). A merchant might, for example, specify an in-person showing of boat 1310 as a deal-progression state (e.g. a TSS) and an email offer of a test drive as a customer-support action (e.g. a TSA).

With knowledge of the transaction type, framework 135ᵢ retrieves a suitable model 1330 and uses these data to create a record to facilitate boat sales (step 1335). The model reflects policies set up or employed for a suitable transaction type. From general to specific, a starting model might be for sales generally, the sale of goods, the sale of vehicles, or for some subset of vehicles (e.g. boats or speed boats). Sales models might be refined further based on e.g. price, geography, or details relating to merchant 1305 and prospective customers. Framework 135i creates or updates a record with deal-progression states and customer-support actions gleaned from information 1320 and 1330. Next, in step 1340, framework 135ᵢ assigns one or more TSSs with associated time factor to each deal progression state, each time factor (AgeoftheRecord) being the time interval for which the deal has been in this current state since record creation. Then, in step 1345, framework 135ᵢ assigns one or more TSAs with time factors to each customer-support action. In this case, the time factor (ActionDueTime) refers to the time interval in which the TSA should be executed.

A transition counter matrix TCM is created, maintained, or updated for each TSA (step 1350) to capture the number of historical transitions from each current TSS to each next TSS. A probability transition matrix PTM is then computed or updated from the TCM for all TSAs (1355). A policy data structure Pol is then created or updated based on the current PTM to give a probabilistic mapping suggesting the best TSA for each TSS (1360).

With the policy in place, the merchant-specific G-NOA framework 135ᵢ receives input from prospective customer 1315, an inquiry 1365 as to the availability of boat 1310 for example. Framework 135ᵢ applies the policy to send merchant 1305 a message suggesting a next optimal action NOA 1370, for example call_2 that says to call the customer 1315 within eight to fourteen days, offer a test drive, etc. Framework 135ᵢ keeps track of these interactions between merchant 1305 and customer 1315 and suggests additional NOAs until the transaction advances to the desired goal 1375—the sale of boat 1310 in this example. Merchant/customer interactions and related state transitions are recorded and employed as training data for subsequent policy updates.

### Enhanced Te-Rl Model

The merchant can either follow the G-NOA recommendation or can utilize the past interaction data to decide an action on his own. This puts into perspective that the historical transactions and interactions provide useful insight and govern the decisions of the merchant. So, intuitively, the past data that includes historical experiences such as AgeoftheRecord and action information like CallCount, EventCount, EmailCount, DND_Count, and LastAction is used as a part of the current state description along with the StateName. This forms the basis of the enhanced TE-RL model as shown in FIG. 2 (230) to have a multidimensional state, namely the Enhanced-Time_Sliced_State (E-TSS) to encompass various features as follows:

1. StateName - The state name can be Qualification, Negotiation, Engaged, Prospecting and others.

2. AgeoftheRecord - Age of the record represents the age of a customer’s record at any point in time.

3. CallCount - The number of prior interactions in the form of calls (CALLS) until the point of observation.

4. EventCount - The number of prior interactions in the form of events (EVENTS) until the point of observation.

5. EmailCount - The number of prior interactions in the form of emails (EMAILS) until the point of observation.

6. DND_Count - DND refers to “Do not Do anything”. DND _Count represents the number of times the DND action is taken until the point of observation. DND is a special action made specifically to handle those cases where state transitions occur without any interaction taking place in a customer relationship journey.

7. LastAction - Similar to the above-mentioned interaction counts, the latest action performed by the merchant in the cycle is also an important action information.

For example, a state can be represented as [4,1,2,0,2,1,0], which corresponds to:
4 - StateName (Negotiation)
1 - AgeoftheRecord (age of the record between 4 and 7 days)
2 - CallCount
0 - EventCount
2 - EmailCount
1 - DND_Counts
0 - LastAction (Calls)

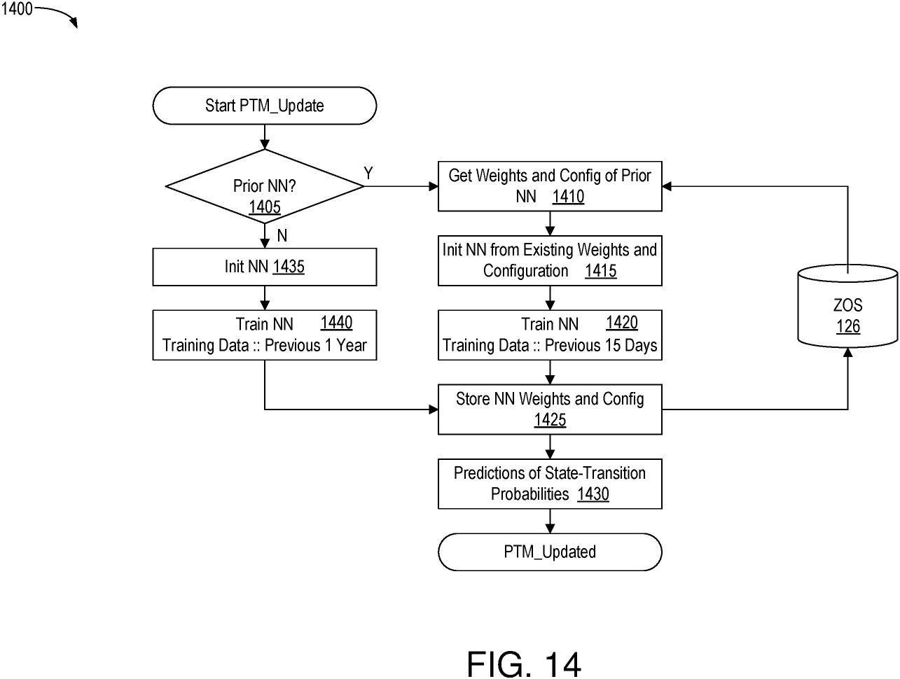

Slicing of the states in Enhanced TE-RL model follows the same procedure of TSS as in FIG. 3 (based on AgeoftheRecord) and includes action information-based slicing for managing the states effectively. The enhanced slicing of states that is followed is termed Enhanced Time_Sliced_State (E-TSS). In the enhanced TE-RL model, an Artificial Neural Network (ANN) is introduced to calculate the transition probabilities whenever required as shown in FIG. 14.

FIG. 14 is a flowchart 1400 detailing an embodiment of step 215 of FIG. 2 in which a Probability Transition Matrix (PTM) is generated and updated using an ANN. The neural network takes in (TSS, TSA) as input and outputs the probabilities of transitioning to states TSS’. The weights of the neural network are saved in ZOS 126 for future use. The transition probabilities are updated e.g. every 15 days when new data is fetched from HDFS 125. The neural network undergoes incremental training as shown in FIG. 14, where the previously saved weights from prior training are fetched from HDFS 125 and used as initial weights to train the model with the new data.

Per decision 1405, if a neural network for the framework under consideration already resides in ZOS 126, then the weights and other configuration data from the prior neural network are retrieved and initialized (steps 1410 and 1415). The neural network is then updated by applying training data accumulated over the last fifteen days (step 1420), after which the update neural network is stored back to ZOS 126 (step 1430). If no neural network is available, decision 1405 causes the framework to initialize a new neural network (step 1435) and apply training data accumulated over the last year (step 1440) before storing the newly form neural network to ZOS 126.

The TE-RL model and its enhanced version (Enhanced TE-RL) play vital roles in G-NOA frameworks to recommend the NOA during the below scenarios,
1. As a response to a merchant’s request.
2. When a new state is reached where in the recommendation is suggested automatically.
3. When the execution time for the last suggested action (action due time) has expired. This puts the environment in a new state and, based on this new state, a new action recommendation is made automatically by the G-NOA framework.
4. A new action is recommended when a previous NOA is executed.

FIG. 15 depicts a general-purpose computing system 1500 that can serve as a client or a server depending on the program modules and components included. One or more computers of the type depicted in computing system 1500 can be configured to implement G-NOA recommender 110 of FIG. 1 and perform the operations described with respect to prior figures. Those skilled in the art will appreciate that the invention may be practiced using other system configurations, including hand-held devices, multiprocessor systems, microprocessor-based or programmable consumer electronics, network PCs, minicomputers, mainframe computers, and the like.

Computing system 1500 includes a conventional computer 1520, including a processing unit 1521, a system memory 1522, and a system bus 1523 that couples various system components including the system memory to the processing unit 1521. The system bus 1523 may be any of several types of bus structures, including a memory bus or memory controller, a peripheral bus, and a local bus using any of a variety of bus architectures. The system memory includes read only memory (ROM) 1524 and random-access memory (RAM) 1525. A basic input/output system 1526 (BIOS), containing the basic routines that help to transfer information between elements within the computer 1520, such as during start-up, is stored in ROM 1524. The computer 1520 further includes a hard disk drive 1527 for reading from and writing to a hard disk, not shown, a solid-state drive 1528 (e.g. NAND flash memory), and an optical disk drive 1530 for reading from or writing to an optical disk 1531 (e.g., a CD or DVD). The hard disk drive 1527 and optical disk drive 1530 are connected to the system bus 1523 by a hard disk drive interface 1532, an SSD interface 1533, and an optical drive interface 1534, respectively. The drives and their associated computer-readable media provide nonvolatile storage of computer readable instructions, data structures, program modules and other data for computer 1520. Other types of computer-readable media can be used.

Program modules may be stored on disk drive 1527, solid state disk 1528, optical disk 1531, ROM 1524 or RAM 1525, including an operating system 1535, one or more application programs 1536, other program modules 1537, and program data 1538. An application program 1536 can used other elements that reside in system memory 1522 to perform the processes detailed above.

A user may enter commands and information into the computer 1520 through input devices such as a keyboard 1540 and pointing device 1542. Other input devices (not shown) may include a microphone, joystick, game pad, satellite dish, scanner, or the like. These and other input devices are often connected to the processing unit 1521 through a serial port interface 1546 that is coupled to the system bus, but may be connected by other interfaces, such as a parallel port, game port, universal serial bus (USB), or various wireless options. A monitor 1547 or other type of display device is also connected to the system bus 1523 via an interface, such as a video adapter 1548. In addition to the monitor, computers can include or be connected to other peripheral devices (not shown), such as speakers and printers.

The computer 1520 may operate in a networked environment using logical connections to one or more remote computers, such as a remote computer 1549 with local storage 1550. The remote computer 1549 may be another computer, a server, a router, a network PC, a peer device, or other common network node, and typically includes many or all of the elements described above relative to the computer 1520. The logical connections depicted in FIG. 15 include a network connection 1551, which can support a local area network (LAN) and/or a wide area network (WAN). Such networking environments are commonplace in offices, enterprise-wide computer networks, intranets, and the Internet.

Computer 1520 includes a network interface 1553 to communicate with remote computer 1549 via network connection 1551. In a networked environment, program modules depicted relative to the computer 1520, or portions thereof, may be stored in the remote memory storage device. It will be appreciated that the network connections shown are exemplary and other means of establishing a communication link between the computers may be used.

While the subject matter has been described in connection with specific embodiments, other embodiments are also envisioned. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A computer system for issuing next-action messages to a plurality of merchants engaged in commercial transactions, the merchants including a first merchant and a second merchant, the computer system comprising:
at least one scheduler to receive a first merchant goal from the first merchant and a second merchant goal from the second merchant, the first merchant goal relating a first customer outcome and the second merchant goal relating a second customer outcome, the scheduler assigning the first merchant goal to a first merchant-goal state corresponding to the first customer outcome and the second merchant goal to a second merchant-goal state corresponding to the second customer outcome;
a first module coupled to the at least one scheduler to produce, from the first merchant goal, a first pre-goal state corresponding to a first stage in a first progression of the first merchant toward the first merchant-goal state; and
a second module coupled to the scheduler to produce, from the second merchant goal, a second pre-goal state corresponding to a second stage in a second progression of the second merchant toward the second merchant-goal state;
wherein the first module assigns a first merchant action to the first pre-goal state and transitions from the first pre-goal state toward the first merchant-goal responsive to the first merchant action; and
wherein the second module assigns a second merchant action to the second pre-goal state and transitions from the second pre-goal state toward the second merchant-goal responsive to the second merchant action.

2. The computer system of claim 1, wherein the first module assigns the first merchant action to the first pre-goal state and the second module assigns the second merchant action to the second pre-goal state.

3. The computer system of claim 1, wherein at least one of the first customer outcome and the second customer outcome comprises a sale to the customer by the merchant.

4. The computer system of claim 1, further comprising storage to store historical state-transition data, wherein the first module reads the pre-goal state and the first merchant action from the historical state-transition data.

5. The computer system of claim 4, wherein the first module assigns a value to the first merchant action based on the historical state-transition data.

6. The computer system of claim 5, wherein the first module computes the value from the historical state-transition data.

7. The computer system of claim 6, further comprising an artificial neural network to compute the value.

8. The computer system of claim 1, further comprising an artificial neural network to compute probabilities of transition from the first pre-goal state to the second pre-goal state responsive to the second merchant action.

9. The computer system of claim 1, the first module further receiving customer feedback in one of the pre-goal states and transitioning, responsive to the customer feedback, to a third pre-goal state.

10. The computer system of claim 9, wherein the third pre-goal state comprises an undesired-goal state.

11. The computer system of claim 9, the first module further to message the first merchant a third merchant action associated with the third pre-goal state.

12. The computer system of claim 11, the first module further to receive a second indication of a third customer in the first pre-goal state and recommending to the first merchant the first merchant action associated with the first pre-goal state.

13. The computer system of claim 12, the first module further to assign a first value to the first merchant action and a second value to a third merchant action, the recommending to the merchant the second merchant action responsive to the second value.

14. The computer system of claim 1, wherein the first merchant action comprises a time-sensitive action, the first module further to recommend to the first merchant an action time with the first merchant action associated with the first pre-goal state.

15. The computer system of claim 14, the first module to transition to a second pre-goal state when the action time expires without the first merchant action.

16. The computer system of claim 14, the first module to transition to a second pre-goal state before the action time and responsive to the first merchant action.

17. The computer system of claim 1, the first module to receive first merchant feedback reporting completion of the first merchant action, transition to a third pre-goal state responsive to the first merchant feedback and recommend to the first merchant a second merchant action associated with the second pre-goal state.

18. The computer system of claim 1, the first module to transition to a third pre-goal state responsive to a passage of time and issue a message to the first merchant recommending a third merchant action associated with the third pre-goal state.

19. A computer system for progressing customer-relationship cycles toward desired goals, the system comprising:
an interface for receiving configurations from respective merchants, each configuration specifying a merchant goal from a respective one of the merchants;
a database correlating the merchants with the merchant goals and storing at least one policy for achieving the merchant goals, the at least one policy including, for each of the merchant goals, a time-sensitive-state data structure specifying time-sensitive states and a time-sensitive-action data structure assigned to the time-sensitive-state data structure and specifying time-sensitive actions; and
an application server coupled to the database and executing a next-optimal-action framework for each of the merchants, each framework including a scheduler instance for issuing recommendations for time-sensitive actions timed to the time-sensitive states.
